(19) United States
(12) Patent Application Publication
(10) Pub. No.: US 2014/0108495 A1
(43) Pub. Date: Apr. 17, 2014

(54) ADAPTIVE STREAMING CLIENT

(71) Applicant: Steven A. Benno, Towaco, NJ (US)

(72) Inventor: Steven A. Benno, Towaco, NJ (US)

(21) Appl. No.: 13/649,429

(22) Filed: Oct. 11, 2012

(51) Int. Cl. G06F 15/16

(52) U.S. Cl. 709/203

(57) ABSTRACT

In one embodiment, an HTTP adaptive streaming client has a processor for controlling the selectable and variable quality level of successive chunks of a multimedia program requested from and transmitted by a server. Chunks are transmitted via a communication path having a variable bandwidth. The processor uses a buffer, a hangover timer, and a plurality of statistical and processing parameters to adaptively react to changes in the bandwidth available on the communication path. Bandwidth changes determined likely to be sustained lead to corresponding changes in the quality of subsequently requested chunks. Statistical parameters based on sliding windows of multiple samples are used to determine whether bandwidth changes are likely to be sustained. The hangover timer is used both to define a sliding window and to prevent successive changes in requested quality from occurring too rapidly so as to provide a relatively smooth viewing experience to a user using the client.

### BACKGROUND

2. Field

The current disclosure relates to adaptive streaming clients, and more specifically, but not exclusively, to clients in HTTP (hypertext transfer protocol) adaptive streaming systems.

2. Description of the Related Art

An item of digital multimedia content, such as a movie, is typically recorded at a high quality, which requires a relatively large number of bits to represent each segment—e.g., one second—of the movie. Many applications do not require—or might not even be able to handle—the highest quality version of the movie since processing a large number of bits in a short period of time is a transport- and computation-intensive endeavor. Consequently, various versions of the movie at corresponding levels of reduced quality—in other words, lower bit rates—may be generated and used for transmission and presentation of the movie to users. Typically, about six to twelve different versions are created, although any number of versions is possible. Each version is segmented into chunks, which are typically each 1-15 seconds long, although other durations are possible. The size of a particular chunk, in terms of data bits used for storage, correlates to the quality level of the version represented. Thus, for example, a chunk of a lower-quality version is represented using fewer bits than the corresponding chunk of a higher-quality version, where corresponding chunks represent the same segment of the movie but at different quality levels.

FIG. 1 shows prior-art adaptive-streaming system 100, which comprises server 101, client 102, and Internet 103. Server 101 is connected to Internet 103 via path 101a, while client 102 is connected to Internet 103 via path 102a. Server 101 provides chunks of multimedia content in one or more of a plurality of available quality levels—i.e., at various bit rates, where a chunk of a particular quality is provided to client 102 in response to a request by client 102 for the chunk at the particular quality. Presently, chunk bit rates typically vary from 300 Kbps to 2.4 Mbps, although in the future these bit rates are likely to increase. Client 102 and server 101 communicate via Internet 103 using a communication protocol such as, for example, HTTP.

Suppose a user at client 102 wishes to view a particular multimedia program, and client 102 learns the program is available from server 101. Using HTTP adaptive streaming (HAS), client 102 first downloads a manifest file for the program from server 101, which lists the available quality levels and chunk information for the program. Then, for each chunk of the program, client 102 makes a corresponding HTTP GET request to server 101. Client 102 first requests a first chunk at the lowest available quality level. Client 102 uses a rate-determination algorithm (RDA) to determine the quality level for requested subsequent chunks. Based on the time required to download a chunk, client 102 calculates the available bandwidth and determines whether a subsequent chunk might be downloadable at a higher quality level. If so, then client 102 requests the subsequent chunk at the higher quality level. Client 102 continues to monitor the download speed of downloaded chunks and adjust the quality of subsequent chunks requested. Depending on client 102's determination of available bandwidth at a particular time, client 102 determines the quality level for the chunks requested following that particular time. As a result, as the program streams to a user, the quality level of sequential chunks may vary in response to variations in the available bandwidth on the path between server 101 and client 102.

If the available bandwidth varies in a jittery manner, then the quality level tends to vary in a correspondingly jittery manner. Such jittery variation in video-quality level of a streaming program may be jarring and annoying to viewers and detract from their viewing experience. Even relatively small variations in bandwidth can cause quality levels to repeatedly oscillate up and down, which may also be annoying to viewers. One way to reduce viewing jitter is to use a larger buffer. However, a larger buffer increases latency between download and viewing, which is particularly undesirable for streaming live programs. Another way to reduce viewing jitter is to use a conservative RDA which keeps quality at a very safe low level, but such an RDA would fail to take advantage of available bandwidth and fail to provide the quality viewing experience the user may be able to enjoy.

### SUMMARY

One embodiment of the disclosure can be a method for a client adapted to receive, from a server in a data-streaming system, content in the form of a plurality of chunks. The method comprises (a) the client receiving a first chunk at a first quality level and (b) the client requesting a second chunk at a second quality level higher than the first quality level if the client determines that a quality-level increase to the second quality level is warranted based on an evaluation performed after receiving the first chunk. The evaluation determines whether a subset of a contiguous plurality of previously downloaded chunks satisfies a comparison with a set of one or more statistical parameters.

Another embodiment of the disclosure can be a client device in a data-streaming system. The client comprises a processor and a memory. The client device is adapted to: (a) receive, from a server in the data-streaming system, contents in the form of a plurality of chunks, (b) receive a first chunk at a first quality level, (c) determine that a quality-level increase to the second quality level is warranted based on an evaluation performed after receiving the first chunk, wherein the evaluation determines whether a subset of a contiguous plurality of previously downloaded chunks satisfies a comparison with a set of one or more statistical parameters, and (d) request a second chunk at a second quality level higher than the first quality level if the client determines that the quality-level increase is warranted.

Yet another embodiment of the disclosure can be a method for a client adapted to receive, from a server in a data-streaming system, content in a the form of a plurality of chunks. The method comprises: (a) the client receiving a first chunk at a first quality level, (b) the client determining a set of download statistics for the first chunk, (c) the client setting one or more dynamically adjustable thresholds based on the determined set of download statistics, and (d) the client requesting a second chunk at a second quality level higher than the first quality level if the set of download statistics for the first chunk satisfies a comparison with the dynamically adjustable thresholds.

### BRIEF DESCRIPTION OF THE DRAWINGS

Other aspects, features, and advantages of the disclosure will become more fully apparent from the following detailed description, the appended claims, and the accompanying drawings in which like reference numerals identify similar or identical elements.

FIG. 1 shows a simplified block diagram of a prior-art adaptive-streaming system.

FIG. 2 shows a simplified block diagram of an adaptive-streaming system in accordance with one embodiment of the disclosure.

FIG. 3 shows a flowchart for exemplary operation of the client of FIG. 2 in accordance with one embodiment of the disclosure.

FIG. 4 shows a simplified block diagram of an adaptive-streaming system in accordance with one alternative embodiment of the disclosure.

FIG. 5 shows a flowchart for an exemplary implementation of a step of FIG. 3, in accordance with one embodiment of the disclosure.

### DETAILED DESCRIPTION

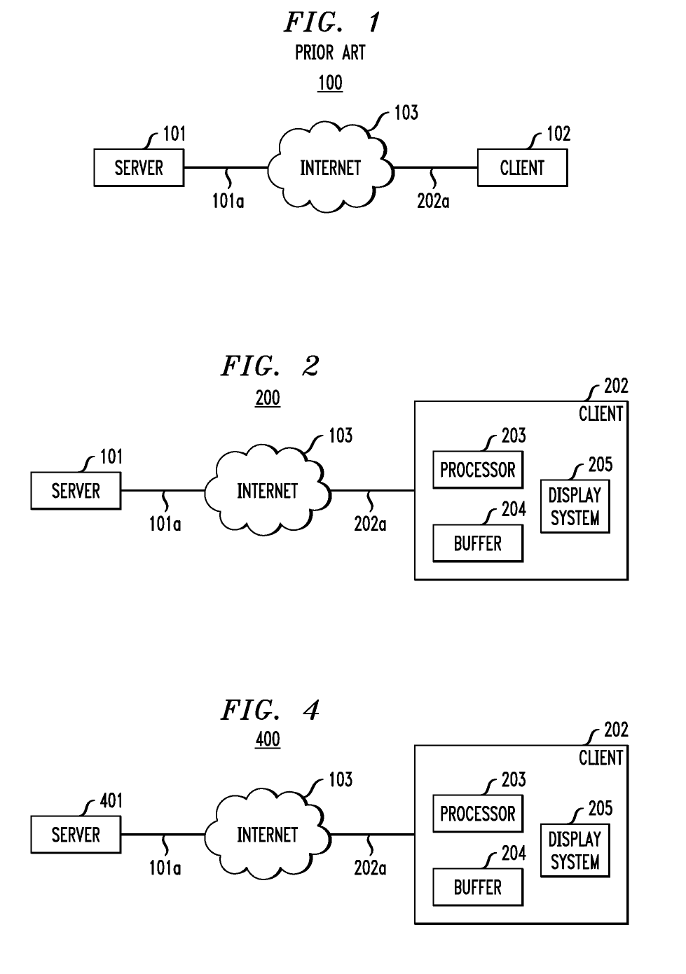

FIG. 2 shows adaptive-streaming system 200 in accordance with one embodiment of the disclosure. System 200 is similar to system 100 of FIG. 1, but with client 102 replaced by client 202 and, correspondingly, path 102a replaced by path 202a. Client 202 may be a stationary computing device where path 202a may be wired and/or wireless. Alternatively, client 202 may be a mobile device, where path 202a is at least partially wireless. Note that the paths of FIG. 2 are simplified representations, and the actual paths may contain pluralities of intermediary signal-transport devices (not shown).

Client 202 comprises processor 203, memory buffer 204, and display system 205. Processor 203 controls client 202. Buffer 204 is a first-in first-out (FIFO) buffer that provides temporary buffer storage for chunks downloaded from server 101 prior to their provision to display system 205. Display system 205 displays the downloaded chunks to a user.

Client 202 uses an algorithm that presents to the user smooth streaming video that avoids jittery fluctuations in streaming video quality even when the available bandwidth varies in a jittery manner. Client 202 uses a buffer length long enough to avoid stuttering display on display system 205 from short transmission interruptions, yet short enough to provide almost instant display of content for live streaming applications. In addition, client 202 uses a hangover timer for preventing consecutive quality changes from occurring too close to each other in time. The algorithmic resetting and assessing of the hangover timer is also used to define a moving window of samples, as described further below. A hangover timer is used to determine whether sufficient time has elapsed from a timer-reset event, which can then be used to allow certain actions to take place. This is done by preventing those certain actions unless the hangover timer is expired. A hangover timer, which starts counting down at the timer-reset event from an initial value, expires when it reaches zero. Furthermore, client 202 uses a collection of dynamically adjustable parameters, such as thresholds, to fine-tune actions during operation.

Client 202 may operate in any one of several modes. After a multimedia program for streaming is identified, streaming begins in startup mode. In startup mode, client 202 initially downloads low-quality chunks and—to the extent possible, as determined by collected download statistics—rapidly raises the quality of the requested chunks to a level determined to be supportable in steady state. After startup, the client operates in a steady-state mode where jittery quality changes are avoided by using one or more of the systems and methods described below. In steady-state operation, client 202 requests chunks at a quality level that keeps memory buffer 204 relatively full while continuously providing chunks to display system 205. Quality level increases are possible in steady-state operation in response to relatively long-term increases in bandwidth, but generally not before the expiry of a corresponding hangover timer.

Since sudden and drastic drops in bandwidth may occur at any time—especially, for example, on wireless networks where client 202 is mobile and the user is moving—client 202 is adapted to react with a panic response if a bandwidth drop is sufficiently deep. If client 202 is recovering after a panic response, then client 202 operates in buffering mode, which is an operational mode for rapidly filling up buffer 204 and returning to steady-state mode. The particular mode in which client 202 is operating when the download of a chunk is completed helps determine how the various parameters used and maintained by processor 203 may be modified. The term parameter as used herein, unless otherwise indicated, refers to a term that represents a numeric value that is used in processing by processor 203. A particular parameter may be used as a variable or a constant. The particular parameter names used herein are used for convenience in describing the operation of client 202 and are not necessary for the disclosure.

Client 202 refers to and updates a plurality of parameters upon the completion of the download of a chunk. The updated parameters are then used in determining the operation of client 202 and the quality level of requested subsequent chunks. Client 202 tracks both (i) parameters related to only the last downloaded chunk and (ii) parameters related to one or more moving windows of pluralities of past chunks.

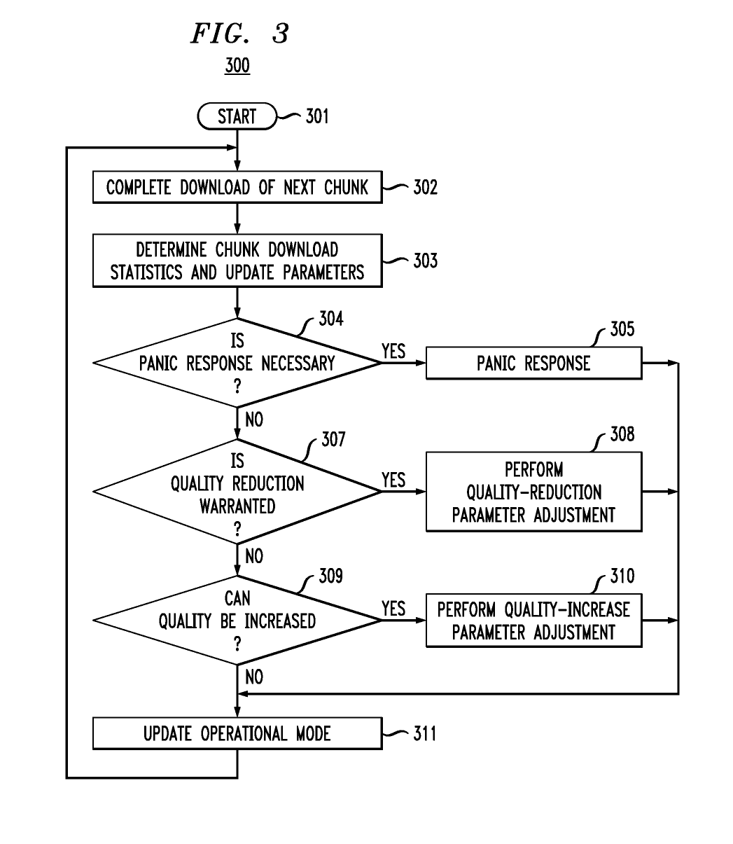

FIG. 3 shows flowchart 300 for exemplary operation of client 202 of FIG. 2 in accordance with one embodiment of the disclosure. The operation starts (step 301) with an acquisition of information by client 202 for the streaming download of a multimedia program from server 101. Client 202 then requests and downloads a next chunk (step 302). Note that the next chunk may be the first chunk of the program. After the completion of the chunk download (step 302), processor 203 (i) determines download statistics based on measurements related to the download of the chunk and (ii) updates statistical and process parameters as warranted (step 303). Exemplary particular parameters are described in greater detail below. Generally, statistical parameters relate to measurements related to bandwidth and buffer fullness, and process parameters are used in determining how the process is to proceed in requesting subsequent chunks. Client 202 calculates statistics for (i) the just-downloaded chunk and (ii) one or more moving windows of a plurality of recently downloaded chunks.

Based on the updated parameters, processor 203 then determines if a panic response is warranted (step 304), and if so, what kind of panic response. A full panic response may be deemed warranted if, for example, the buffer is starved (i.e., near or at depletion), the last chunk took an excessive amount of time to download (e.g., more than a specified download-time threshold value), and/or the smoothed bandwidth—which is the average bandwidth over a moving window of chunks—has plunged precipitously (e.g., by more than specified threshold value). A minor panic response may be deemed warranted if, for example, the smoothed bandwidth falls below a threshold not as low as that which would trigger a full panic response.

If it is determined that a panic response is warranted (step 304), then a panic response is taken (step 305). The panic response (step 305) includes a decrease in quality of the next chunk requested and/or modifying certain parameters. After a panic response (step 305), the process updates the operational mode (step 311) to enter buffering mode and then returns to step 302 for downloading the next chunk. If no panic response is deemed warranted (step 304), then processor 203 determines whether a quality reduction for the next requested chunk is warranted (step 307).

Processor 203 may determine that a quality reduction is warranted (step 307) if, for example, the smoothed bandwidth falls below a threshold. If processor 203 determines that a quality reduction is warranted (step 307), then processor 203 performs the appropriate parameter adjustments for reducing the quality for the next requested chunk (step 308), and the process updates the operational mode, as warranted, (step 311) and then returns to step 302 to download the next chunk.

If it is determined that a quality reduction is not warranted (step 307), then processor 203 determines whether the quality can be increased (step 309). Processor 203 may determine that the quality may be increased if, for example, (i) the hangover timer has expired, (ii) the download of the last chunk met certain bandwidth criteria, (iii) one or more bandwidth parameters have remained above one or more corresponding thresholds for a specified set of previously downloaded chunks and (iv) one or more buffer fullness parameters have remained above one or more corresponding thresholds for a specified set of previously downloaded chunks. If processor 203 determines that quality may be increased (step 309), then processor 203 performs the appropriate parameter adjustments for increasing the quality for the next requested chunk (step 310), and the process updates the operational mode, as warranted, (step 311) and then returns to step 302 to download the next chunk.

If it is determined that quality should not be increased (step 309), then the process updates the operational mode, as warranted, (step 311) and then returns to step 302 to download the next chunk without changing the requested quality level for the next requested chunk. The process terminates automatically (not shown) after the last chunk of the program is downloaded. The process can also terminate in response to other circumstances such as, for example, if the connection between server 101 and client 202 is dropped for more than a specified period or in response to certain actions by the user.

If the requested quality level is changed in the above-described processing, then the hangover timer is reset. The duration to which the hangover timer is reset depends on the operational mode at the time of reset. The duration is longest—e.g., 90 seconds—in steady state mode, shorter—e.g., 30 seconds—in buffering mode, and shortest—e.g., 10 seconds—in startup mode. Note that additional events may trigger a reset of the hangover timer.

Parameters used by a particular implementation of client 202 are described in detail below, together with exemplary values for process parameters. Further below appears an algorithm in accordance with an embodiment of the disclosure that uses these parameters.
SampleWindowSize: the size of a sliding (also called moving) window of samples used for statistical calculations, measured in number of chunks. Typical values range from 1 to 100 chunks, and a value of 30 chunks is used in this implementation.
ChunkDuration: the duration of a chunk, measured in seconds of play time. Typical values range from 1 to 15 seconds, and a value of 2 seconds is used in this implementation.
DownloadDuration: time, in seconds, taken to download a particular chunk.
ChunkSize: the size of a chunk measured in bytes. The size of a chunk depends on the particular quality level and may also depend on the content of the chunk (for example, in variable-bit-rate encoding schemes), where, for example, a first chunk at a particular quality level may comprise more bytes than a second chunk of the same duration at the same quality level, if the scene depicted in the first chunk is more visually complex than the scene depicted in the second chunk.
HangoverTime: the time duration since the last reset event, in seconds, measured by a hangover timer. Hangover timers typically run to no more than 180 seconds. The hangover time may depend on the operational mode. In this implementation, HangoverTime is 10 seconds in startup mode, 30 seconds in buffering mode, and 90 seconds in steady-state mode.
InstantBandwidth: the effective bandwidth for a downloaded chunk, measured in bits per second (b/s), calculated by dividing ChunkSize of the chunk (converted into bits) by the DownloadDuration for the chunk (in seconds).
SmoothedBandwidth: the moving average of the values of InstantBandwidth for the last <SampleWindowSize> number of chunks. In other words, SmoothedBandwidth for a current chunk is the average bandwidth of <SampleWindowSize> chunks in a sliding window trailing the current chunk. Note that, depending on the implementation, the trailing window might or might not include the current chunk.
σ: the standard deviation of the <SampleWindowSize> number of values of InstantBandwidth in the above-described sliding window.
EstimatedBandwidth: an estimated bandwidth value for likely available future bandwidth. EstimatedBandwidth is used in determining available quality levels for a subsequently requested chunk. EstimatedBandwidth, in this implementation, is calculated using Equation (1), below.

EstimatedBandwidth=SmoothedBandwidth−EBConstant*σ (Eq. 1)

where EBConstant is a multiplicative constant whose value may vary
depending on the process determining EstimatedBandwidth. EBConstant is typically set to be between zero and SmoothedBandwidth/σ. In this implementation, EBConstant is set to 0.5 during normal operation, 1.5 in a minor panic response, and 2.0 in a full panic response.
DownloadRatio: a statistical parameter tracking the download ratio for a chunk calculated by dividing the DownloadDuration of the chunk (in seconds) by the ChunkDuration of the chunk (in seconds), i.e., DownloadDuration/ChunkDuration. Generally, in steady-state operation, it is desirable to keep this value, on average, just under 1, which means that an average chunk is downloaded in slightly less time than the duration of the chunk.
MaxBufferSize: the maximum size, in seconds, of the download buffer. Note that the number of bytes needed to store <MaxBufferSize> seconds of content may vary depending on the sum of the values of ChunkSize of the chunks in the buffer. Note further that the buffer may simultaneously store chunks of different quality levels. In one embodiment of the disclosure, MaxBufferSize is 30 seconds.
BufferFullness: a measure of buffer fullness calculated as the sum of the values of ChunkDuration of the chunks in the buffer. If, as is typical, all the chunks in the buffer have the same ChunkDuration value, then the value of BufferFullness can be calculated as (number of chunks in the buffer)*(ChunkDuration). BufferFullness typically ranges from zero to MaxBufferSize.
SmoothedBufferFullness: the average of BufferFullness of the last <BufferFullnessWindow> BufferFullness samples. In other words, the SmoothedBufferFullness for a current chunk is the average buffer fullness of <BufferFullnessWindow> chunks in a sliding window trailing the current chunk.
BufferFullnessWindow: the number of samples in a sliding window of BufferFullness values. BufferFullnessWindow is set to 3 in this implementation.
ReferenceBufferFullness: a reference value for BufferFullness—therefore, in seconds—that is updated upon the occurrence of certain events, such as changes in quality level of requested chunks.
LowerFullnessThreshold: a lower threshold level for buffer fullness that is measured in seconds and calculated as LFTConstant*ReferenceBufferFullness.
LFTConstant: a multiplicative constant whose value typically ranges from zero to one and is 0.8 in this implementation. Note that the value of LowerFullnessThreshold is updated when ReferenceBufferFullness is updated. Generally, LowerFullnessThreshold may be set to any value from zero to MaxLFTConstant*MaxBufferSize.
MaxLFTConstant: a multiplicative constant for MaxBufferSize, whose value may be set to any value from zero to one and is 0.64 in this implementation. MaxLFTConstant is used, e.g., for setting a maximum value for LowerFullnessThreshold.
MinLFTConstant: a multiplicative constant for scaling SmoothedBufferFullness, which may be set to any value from zero to one and is 0.8 in this implementation. MinLFTConstant is used, e.g., for setting a minimum value for LowerFullnessThreshold.
UpperFullnessThreshold: an upper threshold level for buffer fullness that is measured in seconds and calculated as ReferenceBufferFullness+UFTConstant.
UFTConstant: an additive constant whose value is 10 seconds in this implementation. UFTConstant may be set to any value from LowerFullnessThreshold to MaxUFTConstant*MaxBufferSize.
MaxUFTConstant: a multiplicative constant that may be set to any value from zero to one and is set to 0.99 in this implementation.
StateTimeout: a threshold, measured in seconds, for exiting from an operational mode intended to be temporary, such as startup and buffering modes. In this implementation, StateTimeout is set to 23 seconds in startup mode and 50 seconds in buffering mode.
PanicLFThreshold: a buffer-fullness threshold value used as a factor to determine whether a full panic response is warranted. In the present implementation, PanicLFThreshold is set to a fraction of LowerFullnessThreshold, such as 0.5*LowerFullnessThreshold. A panic response may be deemed warranted if, for example, SmoothedBufferFullness<PanicLFThreshold.
MinorPanicLFThreshold: a buffer-fullness threshold value used as a factor to determine whether a minor panic response is warranted. In this implementation, MinorPanicLFThreshold is set to a fraction of LowerFullnessThreshold, such as 0.75*LowerFullnessThreshold. A minor panic response may be deemed warranted if, for example, a full panic response is not deemed warranted, but SmoothedBufferFullness<MinorPanicLFThreshold.
PanicDDThreshold: a download-duration threshold value used as a factor in determining whether a panic response is warranted. In this implementation, PanicDDThreshold is set to a multiple of ChunkDuration, such as 2.5*ChunkDuration. A panic response may be deemed warranted if, for example, DownloadDuration>PanicDDThreshold. Note that this is equivalent to deeming a panic response warranted if DownloadRatio>2.5. In other words, the multiplicative constant used for PanicDDThreshold can be used as a download-ratio threshold.
PanicSBFullnessThreshold: a buffer fullness threshold value used as a factor in determining whether a panic response is warranted. In the present implementation, PanicSBFullnessThreshold is set to a constant number of seconds, such as 5 seconds. A panic response may be deemed warranted if, for example, SmoothedBufferFullness<PanicSBFullnessThreshold.
NextBitRate: the nominal bit rate, measured in, for example, bits/sec, of the next higher quality level than the quality level of the present chunk. If the present chunk is at the highest quality level, then the NextBitRate may be, for example, (1) set to the current bit rate or (2) set to a null value.

In the implementation using the above-described parameters, the streaming download starts in startup mode, where HangoverTime is set to 10 seconds, and quality-level increases may jump several levels at a time. Steady-state mode is entered if (i) the hangover time has expired and (ii) it is determined that quality cannot be increased again. Also steady-state mode commences if the process has been in startup mode longer than the value of <StateTimeout> for startup mode. In startup mode, SmoothedBandwidth and EstimatedBandwidth are calculated using the available chunks (up to <SampleWindowSize>) as the sliding windows fills up.

After a chunk is downloaded, parameters such as EstimatedBandwidth are determined as described above. If a quality change is deemed warranted, then (i) ReferenceBufferFullness is set to BufferFullness, (ii) LowerFullnessThreshold is set to LFTConstant*ReferenceBufferFullness, (iii) UpperFullnessThreshold is set to ReferenceBufferFullness+UFTConstant. In other words, if a quality change is deemed warranted, then the following parameter values are set:
ReferenceBufferFullness=BufferFullness,
LowerFullnessThreshold=LFTConstant*ReferenceBufferFullness, and
UpperFullnessThreshold=ReferenceBufferFullness+UFTConstant.

If the value of BufferFullness for the downloaded chunk is higher than the previous value of BufferFullness, then the lower and upper fullness thresholds may be raised up to, or capped at, certain limits, in accordance with the following conditions:
if LowerFullnessThreshold<MinLFTConstant*SmoothedBufferFullness, then LowerFullnessThreshold is raised to MinLFTConstant*SmoothedBufferFullness, but
if LowerFullnessThreshold>MaxLFTConstant*MaxBufferSize, then LowerFullnessThreshold is capped at MaxLFTConstant*MaxBufferSize.
if UpperFullnessThreshold<SmoothedBufferFullness, but not all conditions for increasing the quality level are met, then UpperFullnessThreshold is raised to SmoothedBufferFullness, but
if UpperFullnessThreshold>MaxUFTConstant*MaxBufferSize, then UpperFullnessThreshold is capped at MaxUFTConstant*MaxBufferSize.

If (i) BufferFullness falls below UpperFullnessThreshold or (ii) EstimatedBandwidth falls below NextBitRate, then the hangover timer is reset. If the hangover timer is expired, then it is determined whether a quality change should be made. The quality level is increased by one level if (i) for each chunk downloaded during the last <HangoverTime> seconds, SmoothedBufferFullness>=UpperFullnessThreshold, (ii) for each chunk downloaded during the last <HangoverTime> seconds, EstimatedBandwidth>NextBitRate, and (iii) the InstantBandwidth for the last downloaded chunk is greater than EstimatedBandwidth. Note that under certain circumstances—such as, for example, in startup and/or buffering modes—the quality level increase may be a jump of more than one level.

Quality level is decreased by one level or to the highest rate below EstimatedBandwidth, whichever is lower, if SmoothedBufferFullness<=LowerFullnessThreshold. If it is determined that the quality level should be decreased, then it is determined whether a panic response is warranted, as described above. If a full panic response is deemed warranted, then EstimatedBandwidth is set, as described above for full and minor panic responses, and then the bandwidth values in the moving window are replaced with the present value of EstimatedBandwidth. Following the panic response, the process goes into buffering mode, as described above.

FIG. 4 shows system 400 in accordance with one alternative embodiment of the disclosure. System 400 is substantially similar to system 200 of FIG. 2, but with server 101 replaced by server 401. In system 400, server 401 provides to client 202 a streaming player that allows execution of a process in accordance with an embodiment of the disclosure. In other words, instructions—embedded in the streaming player—for enabling client 202 to stream multimedia content from server 401 are provided by server 401 to client 202. In some implementations, a player is downloaded by client 202 from server 401 before every program is downloaded from server 401. In some implementations, the player is downloaded once per communication session between server 401 and client 202. In some implementations, the player is downloaded the first time that client 202 communicates with server 401 and later only if updates or reinstallations are warranted. In some implementations, the player is only downloaded by client 202 from server 401 only if client 202 needs a new or updated player.

An embodiment of the disclosure has been described where it is determined that the quality may be increased if certain criteria are met for each of the chunks of the last <HangoverTime> number of seconds. In some alternative embodiments, the criteria have to be met for only a proper subset of those chunks. These criteria are referred to as forgiveness criteria. The subset may be set to be, for example, (i) a percentage, such as 90%, of the chunks, (ii) at least a certain number, such as 20, of the chunks, (iii) at most a certain number of chunks, such as 2, fail the criteria, or (iv) a subset where no two (or other integer) consecutive chunks fail the criteria. One way to implement one such more-flexible embodiment is to (i) use a parameter that counts the number of chunks violating the criteria during a hangover timer period and (ii) reset the hangover timer only if the number of criteria violations exceeds a certain threshold, such as 2. Using forgiveness criteria increases the likelihood that a higher-quality stream would be provided to the user.

Embodiments of the disclosure have been described where the determination of whether to increase the quality of a subsequently requested chunk depends on the evaluation of each sample of a moving window—e.g., a moving window that is <HangoverTime> number of seconds long—of previously downloaded chunks, where a subset of the samples is determined to satisfy a comparison with defined statistical criteria. The subset may include all of the samples of the moving window—if no forgiveness criteria are used. Or, if forgiveness criteria are used, then the subset may be a proper subset—i.e., including some, but not all of the samples—of the moving window. It should be understood that use of forgiveness criteria does not require that only a proper subset of samples meet the statistical criteria, but, rather, that the use of forgiveness criteria allows a quality increase if at least some—and certainly if all—of the samples meet the statistical criteria. As would be appreciated by a person of ordinary skill in the art, there are multiple ways to achieve the desired evaluation.

One way to achieve the desired evaluation, referred to herein as an expanded evaluation, would be to maintain information on each sample in the moving window and evaluate all the samples of the moving window, or their corresponding information, after the download of every new chunk. Another way, referred to herein as a compact evaluation, is to use evaluations of newly downloaded chunks to selectively trigger a reset of the hangover timer. If no forgiveness criteria are used, then, if a determination that a newly downloaded chunk fails to meet a defined statistical criteria triggers a reset of the hangover timer, then the hangover timer cannot expire unless and until each sample of the moving window meets the defined statistical criteria. If forgiveness criteria are used, then, if a determination that both (i) a newly downloaded chunk fails to meet a defined statistical criteria and (ii) the forgiveness criteria are not met, triggers a reset of the hangover timer, then the hangover timer cannot expire unless and until at least a proper subset of the samples of the moving window meets the defined statistical criteria.

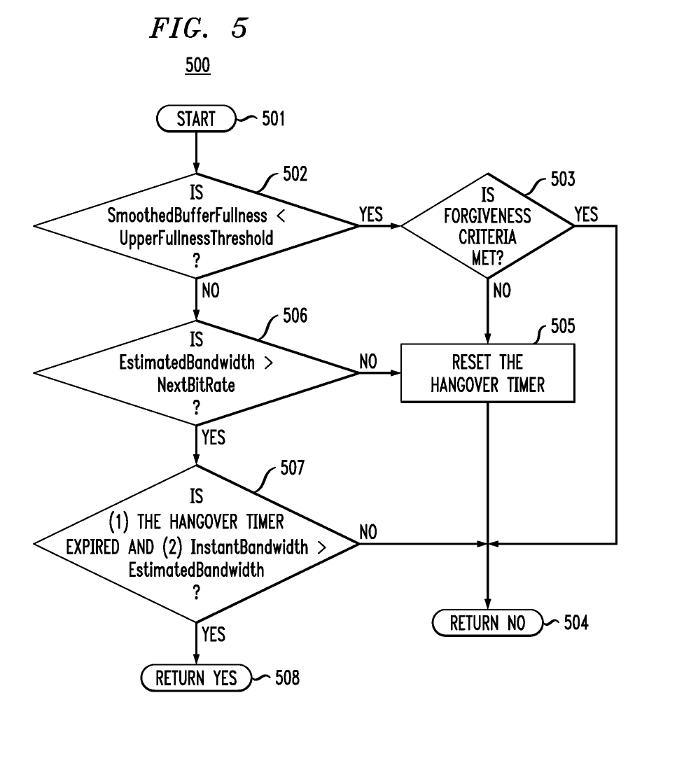

FIG. 5 shows a flowchart for process 500 for an exemplary implementation of step 309 of FIG. 3, in accordance with one embodiment of the disclosure using a compact evaluation. Recall that step 309 determines whether quality can be increased for a subsequently requested chunk. After process 500 starts (step 501), it is determined whether SmoothedBufferFullness<UpperFullnessThreshold (step 502). If step 502′s determination is positive, then it is determined whether any forgiveness criteria are met (step 503). If the forgiveness criteria are met (step 503), then the process terminates returning NO (step 504)—without resetting the hangover timer. If the forgiveness criteria are not met (step 503), then the hangover timer is reset (step 505) and the process terminates returning NO (step 504).

If step 502's determination is positive—in other words, that SmoothedBufferFullness>=UpperFullnessThreshold—then it is determined whether EstimatedBandwidth>NextBitRate (step 506). If step 506's determination is negative, then the hangover timer is reset (step 505) and the process terminates returning NO (step 504). If step 506's determination is positive, then it is determined if (1) the hangover timer has expired and (2) InstantBandwidth>EstimatedBandwidth (step 507). If step 507's determination is negative, then process 500 terminates, returning NO (step 504). Otherwise, if step 506's determination is positive, then process 500 terminates, returning YES as the output of step 309 (step 508).

It should be noted that, although steps 502, 506, and 507 are presented in a particular order here, they do not necessarily have to be performed in that particular order. It should also be noted that, as would be appreciated by a person of ordinary skill in the art, the determination of the above criteria may be made in any of a variety of ways not limited to the comparisons described here. In general, a subsequently requested chunk is requested at a higher quality level if client 202 determines that a quality-level increase to the higher quality level is warranted based on an evaluation of a set of download statistics for a defined set of a plurality of previously downloaded chunks. Note that embodiments of the disclosure have been described where the download statistics include both bandwidth-related and buffer-fullness-related parameters. It should be noted that, in some alternative embodiments, only bandwidth-related parameters or only buffer-fullness-related parameters, but not both, are used in the evaluation.

Embodiments of the disclosure have been described with a particular implementation of a hangover timer. It should be noted that alternative implementations of a hangover timer may be used in alternative embodiments of the disclosure. For example, rather than counting down, a hangover timer may start, at a reset event, to count up to a set value and expire upon reaching that set value.

Embodiments of the disclosure have been described where the downloaded data chunks represent multimedia content. It should be noted, however, that the data chunks do not have to represent any particular kind of data. In alternative embodiments, the data in the data chunks may represent a single medium—e.g., only sound or only visual data—or no medium at all.

Embodiments of the disclosure have been described where the decision point for the processing algorithm is at the end of the download of a chunk. Other decision points, however, may be used instead. In some alternative embodiments, determination, decisions, and/or parameter updates may be made at the download of a multiple of chunks. In some alternative embodiments, determinations, decisions, and parameter changes may be made at set time intervals (e.g., every second). In some alternative embodiments, hybrid decision points may be used, which may depend both on time and chunk-download completions. A person of ordinary skill in the art would understand which corresponding modifications would be necessary to implement the above embodiments.

Embodiments of the disclosure have been described as a series of process steps performed in a certain order. It should be noted that some steps may be reordered or combined without departing from the scope of the disclosure. For example, determining whether a panic response is warranted (step 304 of FIG. 3) may be performed after or in conjunction with determining whether a quality reduction is warranted (step 307). Similarly, either determination may be made after determining whether the quality can be increased (step 309).

Embodiments of the disclosure have been described where a particular threshold value was described as the product of a multiplicative constant and another parameter. Other embodiments of the disclosure may use multiplicative constants different from the ones described above. Different additive constants may also be used. Some embodiments of the disclosure may determine the threshold values using different parameters and/or constants.

References herein to the verb “to set” and its variations in reference to values of fields do not necessarily require an active step and may include leaving a field value unchanged if its previous value is the desired value. Setting a value may nevertheless include performing an active step even if the previous or default value is the desired value.

Unless indicated otherwise, the term “determine” and its variants as used herein refer to obtaining a value through measurement and, if necessary, transformation. For example, to determine an electrical-current value, one may measure a voltage across a current-sense resistor, and then multiply the measured voltage by an appropriate value to obtain the electrical-current value. If the voltage passes through a voltage divider or other voltage-modifying components, then appropriate transformations can be made to the measured voltage to account for the voltage modifications of such components and to obtain the corresponding electrical-current value.

As used herein in reference to data transfers between entities in the same device, and unless otherwise specified, the terms “receive” and its variants can refer to receipt of the actual data, or the receipt of one or more pointers to the actual data, wherein the receiving entity can access the actual data using the one or more pointers.

Exemplary embodiments have been described wherein particular entities (a.k.a. modules) perform particular functions. However, the particular functions may be performed by any suitable entity and are not restricted to being performed by the particular entities named in the exemplary embodiments.

Exemplary embodiments have been described with data flows between entities in particular directions. Such data flows do not preclude data flows in the reverse direction on the same path or on alternative paths that have not been shown or described. Paths that have been drawn as bidirectional do not have to be used to pass data in both directions.

The present invention may be implemented as circuit-based systems, including possible implementation as a single integrated circuit (such as an ASIC or an FPGA), a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless explicitly stated otherwise, each numerical value and range should be interpreted as being approximate as if the word “about” or “approximately” preceded the value of the value or range. As used in this application, unless otherwise explicitly indicated, the term “connected” is intended to cover both direct and indirect connections between elements.

For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. The terms “directly coupled,” “directly connected,” etc., imply that the connected elements are either contiguous or connected via a conductor for the transferred energy.

The use of figure numbers and/or figure reference labels in the claims is intended to identify one or more possible embodiments of the claimed subject matter in order to facilitate the interpretation of the claims. Such use is not to be construed as limiting the scope of those claims to the embodiments shown in the corresponding figures.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

Although the steps in the following method claims are recited in a particular sequence with corresponding labeling, unless the claim recitations otherwise imply a particular sequence for implementing some or all of those steps, those steps are not necessarily intended to be limited to being implemented in that particular sequence.

We claim:

1. A method for a client adapted to receive, from a server in a data-streaming system, content in the form of a plurality of chunks, the method comprising:
(a) the client receiving a first chunk at a first quality level; and
(b) the client requesting a second chunk at a second quality level higher than the first quality level if the client determines that a quality-level increase to the second quality level is warranted based on an evaluation performed after receiving the first chunk, wherein:
the evaluation comprises determining whether a subset of a contiguous plurality of previously downloaded chunks satisfies a comparison with a set of one or more statistical parameters.

2. The method of claim 1, wherein the comparison with the set of one or more statistical parameters comprises determining whether each member of the subset of the contiguous plurality of previously downloaded chunks satisfies (1) a comparison with a set of buffer fullness parameters and (2) a comparison with a set of bandwidth parameters.

3. The method of claim 2, wherein:
for each member of the subset of the chunks, the comparison with a set of buffer fullness parameters is satisfied if it is determined that the smoothed buffer fullness parameter for the chunk is not less than an upper fullness threshold; and
the smoothed buffer fullness for a current chunk is the average buffer fullness of the chunks in a buffer-fullness moving window trailing the current chunk.

4. The method of claim 2, wherein:
for each member of the subset of the chunks, the comparison with a set of bandwidth parameters is satisfied if it is determined that the estimated bandwidth for the chunk is greater than the next bit rate;
the next bit rate is a nominal bit rate for the next higher quality level higher than the first quality level;
the estimated bandwidth is a likely available future bandwidth whose value for a current chunk is determined using the smoothed bandwidth value for the current chunk; and
the smoothed bandwidth value for the current chunk is the average instant bandwidth of a bandwidth moving window of chunks trailing the current chunk.

5. The method of claim 4, wherein:
the value of estimated bandwidth for a current chunk is determined in accordance with the formula estimated bandwidth=SmoothedBandwidth−EBConstant*σ;
SmoothedBandwidth is the smoothed bandwidth value for the current chunk;
EBConstant is a multiplicative constant; and
σ is a standard deviation of instant bandwidths for the chunks in the bandwidth moving window.

6. The method of claim 1, wherein:
the evaluation uses forgiveness criteria; and
the forgiveness criteria permit the subset of chunks that satisfies the comparison with the set of one more statistical parameters to be a proper subset of the contiguous plurality of previously downloaded chunks.

7. The method of claim 1, wherein the evaluation comprises:
determining whether the first chunk satisfies the comparison with the set of one or more statistical parameters;
resetting a hangover timer if it is determined that the first chunk does not satisfy the comparison with the set of one or more statistical parameters, wherein the hangover timer is used to define the contiguous plurality of previously downloaded chunks; and
determining that a quality-level increase is warranted if (a) the hangover timer is expired and (b) it was determined that the first chunk satisfies the comparison with the set of one or more statistical parameters.

8. The method of claim 7, wherein:
the evaluation determines that a quality-level increase is warranted only if the instant bandwidth of the first chunk is greater than the estimated bandwidth value for the first chunk;
the value of estimated bandwidth for a current chunk is determined in accordance with the formula estimated bandwidth=SmoothedBandwidth−EBConstant*σ;
SmoothedBandwidth is the smoothed bandwidth value for the first chunk
the smoothed bandwidth value for the first chunk is the average instant bandwidth of a bandwidth moving window of chunks trailing the first chunk;
EBConstant is a multiplicative constant; and
σ is a standard deviation of instant bandwidths for the chunks in the bandwidth moving window.

9. The method of claim 1, wherein:
the set of one or more statistical parameters comprises one or more dynamically adjustable thresholds;
the evaluation includes determining a set of download statistics for the first chunk and adjusting the one or more dynamically adjustable thresholds based on the determined set of download statistics.

10. The method of claim 1, further comprising:
determining whether a panic response is necessary based on a calculation of a set of download statistics for the first chunk; and
carrying out a panic response if it is determined that a panic response is necessary.

11. The method of claim 10, wherein:
the set of download statistics calculated for the first chunk includes: (a) buffer fullness, (b) download time, and (c) smoothed bandwidth; and
if any of (a) the buffer fullness falls below a buffer fullness threshold, (b) the download ratio is greater than a download-ratio threshold, or (c) the smoothed bandwidth falls below a smoothed bandwidth threshold, then it is determined that a panic response is necessary.

12. The method of claim 10, wherein:
the client is adapted to operate in one of a start-up, a steady-state, and a buffering mode; and
carrying out the panic response includes setting the operational mode of the client to buffering mode.

13. The method of claim 1, wherein:
a hangover timer is used to define the contiguous plurality of previously downloaded chunks;
the evaluation determines that a quality-level increase is not warranted if the hangover timer is not expired; and
the hangover timer is reset if the client determines that a quality-level increase is warranted.

14. A client device in a data-streaming system, the client comprising a processor and a memory, the client device adapted to:
receive, from a server in the data-streaming system, contents in the form of a plurality of chunks;
receive a first chunk at a first quality level;
determine that a quality-level increase to the second quality level is warranted based on an evaluation performed after receiving the first chunk, wherein the evaluation determines whether a subset of a contiguous plurality of previously downloaded chunks satisfies a comparison with a set of one or more statistical parameters;
request a second chunk at a second quality level higher than the first quality level if the client determines that the quality-level increase is warranted.

15. The device of claim 14, wherein:
the comparison with the set of one or more statistical parameters comprises determining whether each member of the subset of the contiguous plurality of previously downloaded chunks satisfies (1) a comparison with a set of buffer fullness parameters and (2) a comparison with a set of bandwidth parameters;
for each member of the subset of the chunks, the comparison with a set of bandwidth parameters is satisfied if it is determined that the estimated bandwidth for the chunk is greater than the next bit rate;
the next bit rate is a nominal bit rate for the next higher quality level higher than the first quality level;
the estimated bandwidth is a likely available future bandwidth whose value for a current chunk is determined using the smoothed bandwidth value for the current chunk;
the smoothed bandwidth value for the current chunk is the average instant bandwidth of a bandwidth moving window of chunks trailing the current chunk;
the value of estimated bandwidth for a current chunk is determined in accordance with the formula estimated bandwidth=SmoothedBandwidth−EBConstant*σ;
SmoothedBandwidth is the smoothed bandwidth value for the current chunk;
EBConstant is a multiplicative constant; and
σ is a standard deviation of instant bandwidths for the chunks in the bandwidth moving window.

16. The device of claim 14, wherein:
the evaluation uses forgiveness criteria; and
the forgiveness criteria permit the subset of chunks that satisfies the comparison with the set of one more statistical parameters to be a proper subset of the contiguous plurality of previously downloaded chunks.

17. The device of claim 14, wherein the evaluation comprises:
determining whether the first chunk satisfies the comparison with the set of one or more statistical parameters;
resetting a hangover timer if it is determined that the first chunk does not satisfy the comparison with the set of one or more statistical parameters, wherein the hangover timer is used to define the contiguous plurality of previously downloaded chunks; and
determining that a quality-level increase is warranted if (a) the hangover timer is expired and (b) it was determined that the first chunk satisfies the comparison with the set of one or more statistical parameters.

18. The device of claim 14, wherein:
the set of one or more statistical parameters comprises one or more dynamically adjustable thresholds;
the evaluation includes determining a set of download statistics for the first chunk and adjusting the one or more dynamically adjustable thresholds based on the determined set of download statistics.

19. The device of claim 14, wherein:
the device is adapted to calculate a set of download statistics for the first chunk;
the set of download statistics calculated for the first chunk includes: (a) buffer fullness, (b) download time, and (c) smoothed bandwidth; and
if any of (a) the buffer fullness falls below a buffer fullness threshold, (b) the download ratio is greater than a download-ratio threshold, or (c) the smoothed bandwidth falls below a smoothed bandwidth threshold, then it is determined that a panic response is necessary.

20. A method for a client adapted to receive, from a server in a data-streaming system, content in a the form of a plurality of chunks, the method comprising:
the client receiving a first chunk at a first quality level;
the client determining a set of download statistics for the first chunk;
the client setting one or more dynamically adjustable thresholds based on the determined set of download statistics;
the client requesting a second chunk at a second quality level higher than the first quality level if the set of download statistics for the first chunk satisfies a comparison with the dynamically adjustable thresholds.
